(19) United States
(12) Patent Application Publication
(10) Pub. No.: US 2004/0243451 A1
(43) Pub. Date: Dec. 2, 2004

(54) Shareholder-owned life insurance system and method

(76) Inventors: Howard E. Winklevoss, Greenwich, CT (US); Brett D. Long, Riverside, CT (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/854,637

(22) Filed: May 27, 2004

Related U.S. Application Data
(60) Provisional application No. 60/473,470, filed on May 28, 2003.

(51) Int. Cl. G06F 17/60

(52) U.S. Cl. 705/4

(57) ABSTRACT

Systems and methods provide a shareholder-owned life insurance product enabling a shareholder in a small or closely held company to purchase a large-scale life insurance product, independent of the limited operating budget of his company, in which he can invest a large sum of private wealth. The shareholder can control risk exposure, obtain the tax benefits typically associated with an individual beneficiary life insurance policy, and achieve the cost savings of a large-scale corporation owned life insurance transaction, while avoiding the underwriting restrictions and costs associated with individual insureds and policies with large face amounts.

### RELATED APPLICATION

This application claims priority to U.S. Provisional Application No. 60/473,470, both filed May 28, 2003, which is hereby incorporated by reference.

### DESCRIPTION OF THE INVENTION

1. Field of the Invention

This invention relates generally to financial services and products and more specifically to systems and methods for providing financial services and products including shareholder-owned life insurance.

2. Background of the Invention

An owner (e.g., shareholder) of a small or closely held entity (e.g., company) may wish to protect the value of that company against losses that could occur in the event of the death of one or more employees of the company. The needs of such a shareholder differ in many ways from those of investors in major corporations with publicly traded shares. For example, a shareholder typically has a much greater stake in the company than the typical investor in a publicly traded company. Traditional life insurance products provide death benefit protection to individuals and corporations as the beneficiaries, but such products fail to meet the needs of the shareholder in a closely held company.

Additionally, a shareholder may seek ways to use existing funds for tax-advantaged long-term investment or for higher yielding, but tax inefficient, alternative investments. Traditional investment products, including life insurance with an individual beneficiary and life insurance with a corporation as beneficiary, do not always meet these needs.

Life Insurance with Individual Beneficiary

One presently available product is life insurance with an individual as the beneficiary. Any individual, such as a shareholder, can purchase life insurance on his or her own life or on the life of another individual and enjoy the tax advantages of investing in life insurance. The individual insured must pass the insurance company's underwriting process, however, and older individuals may find it difficult to meet the underwriting requirements for a life insurance policy for any significant amount of money. If the available amount of insurance is limited, so is the potential investment and the associated tax benefits.

A further limitation on the individual beneficiary life insurance product is that policies designed for individual insureds bear a higher overall cost structure because individuals generally do not qualify for institutional pricing discounts that an insurance company may offer to corporations or companies. Individual insureds also cannot achieve an “experience rating,” which requires a large number of insureds and permits a policy owner to participate in mortality experience to obtain lower rates. Finally, policies designed for individual insureds do not provide access to institutional money managers, which generally require substantial amounts of funds to be invested, such as $10 million or more.

Life Insurance with Corporate Beneficiary

Another conventional practice uses life insurance to protect a corporation having an interest in the lives of its employees. Three types of this insurance are: key-person life insurance, corporate owned life insurance, and bank owned life insurance.

Key-Person Life Insurance: Many partnerships and closely held corporations maintain “Buy/Sell” agreements stipulating that the partnership or corporation will purchase the shares of a deceased partner or shareholder. Key-Person life insurance is traditionally purchased by a partnership or a closely held corporation on the lives of the partners or shareholders to provide the funds to fulfill the Buy/Sell agreement. Key-Person policies may be used in other situations, such as providing collateral for a loan or naming either a purchasing business or a business with a substantial exposure to key employees (such as a lender) as the beneficiary of the death benefit.

However, traditional key-person insurance does not adequately address the needs of a shareholder described above. Because key-person policies generally insure a small number of individuals, they suffer from many of the drawbacks associated with individual beneficiary life insurance policies, such as strict underwriting rules and higher costs.

Corporate Owned Life Insurance: Corporate owned life insurance (“COLI”) enables a corporation to purchase whole life insurance policies on its directors, officers, or other employees. Traditionally, the corporation is the beneficiary of the death proceeds of the policy as well as the recipient of proceeds from the investment income in the policy. The primary use of COLI is to finance the costs of various employee benefit programs offered to corporate employees. In addition, COLI protects the corporation from the costs associated with the deaths of employees. Because of the number of employees insured, individual underwriting can often be avoided. COLI may be issued as an obligation of the insurance company to pay guaranteed interest rates or as an investment vehicle wherein cash values and death benefits vary based on the investment of funds in a separate account managed by investment managers.

Although a shareholder could authorize his company to purchase a COLI policy directly, current U.S. tax laws encourage shareholders to remove profits from the company to avoid double taxation on such profits. Funds left in the company are generally used for working capital, so the typical shareholder does not have sufficient funds in the company to take advantage of a COLI program. Because COLI does not provide such shareholders with significant tax benefits, it does not meet all of the needs of a shareholder in a small or closely held company.

None of the conventional insurance products adequately meets the needs of a shareholder seeking both to protect his ownership interest in a small or closely held company and to profit from tax-advantaged long-term investments or higher yielding, but tax inefficient, alternative investments.

### SUMMARY OF THE INVENTION

The present invention provides systems and methods for a shareholder in a small or closely held company to purchase a large-scale life insurance product, independent of the limited operating budget of his company, in which he can invest a large sum of private wealth. These systems and methods allow the shareholder to control risk exposure, obtain the tax benefits typically associated with an individual beneficiary life insurance policy, and achieve the cost savings typically found in a large-scale COLI transaction. At the same time, these systems and methods avoid the underwriting restrictions and costs associated with individual insureds and policies with large face amounts.

Consistent with the present invention, a company's shareholder may protect the value of his ownership interest in the company against any losses that might occur in the event of the death of one or more of the company's employees by obtaining a shareholder-owned life insurance (SHOLI) product. A SHOLI combines the benefits of a large-scale insurance policy with tax-free investment growth.

Additional objects and advantages of the invention will be set forth in part in the description that follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a block diagram of a system consistent with an exemplary embodiment of the present invention;

FIG. 2 is a block diagram of a SHOLI product in greater detail consistent with an exemplary embodiment of the present invention;

FIG. 3 is a flow chart depicting a process for providing a SHOLI product with a supplemental death benefit consistent with an exemplary embodiment of the present invention;

FIG. 4 is a flow chart depicting a process when an insured employee dies under a SHOLI with a supplemental death benefit consistent with an exemplary embodiment of the present invention;

FIG. 5 is a block diagram of a system consistent with another exemplary embodiment of the present invention;

FIG. 6 is a block diagram of a SHOLI product in greater detail consistent with another exemplary embodiment of the present invention; & the same as FIG. 2

FIG. 7 is a flow chart depicting a process for providing a SHOLI product with a Hybrid Fund consistent with another exemplary embodiment of the present invention;

FIG. 8 is a flow chart depicting a process when an insured employee dies under a SHOLI with a Hybrid Fund consistent with another exemplary embodiment of the present invention; and

FIG. 9 is a block diagram of a data processing system consistent with an embodiment of the present invention.

### DESCRIPTION OF THE EMBODIMENTS

Reference will now be made in detail to several exemplary embodiments illustrated in the accompanying drawings. Wherever possible, the same reference numbers will be used throughout the drawings to refer to the same or like parts.

Overview of Shareholder-Owned Life Insurance (SHOLI)

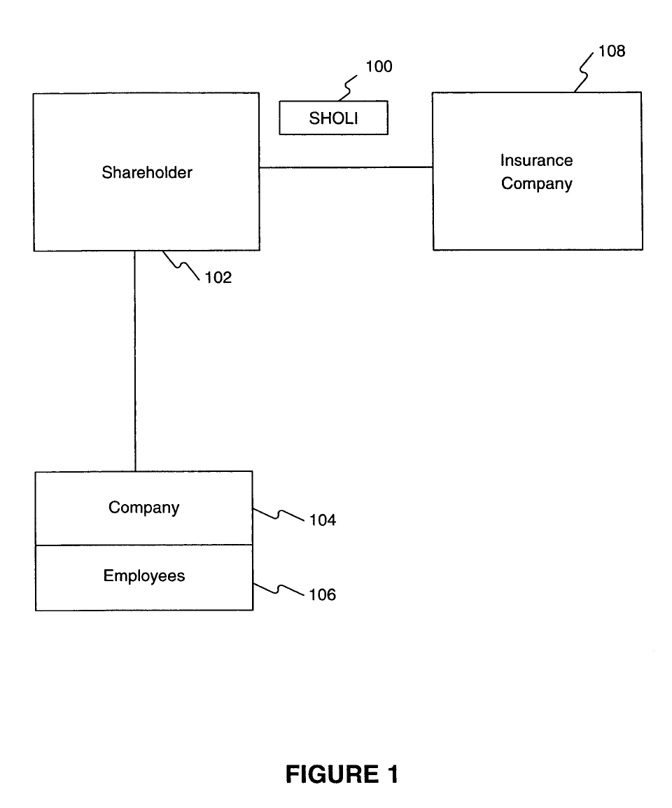

FIG. 1 is a block diagram of a system consistent with the present invention. As shown in FIG. 1, a shareholder-owned life insurance (SHOLI) product 100 includes a life insurance policy owned by a shareholder 102, rather than by his or her company 104. As such, the shareholder receives death benefit protection on the lives of the company's employees 106. An insurance company 108 may provide SHOLI 100 to shareholder 102.

An embodiment consistent with the present invention may be implemented using a computer system. For example, insurance company 108 and/or company 104 may include computer software and/or hardware to facilitate the creation and management of SHOLI 100. Alternatively, a third party may manage SHOLI products for many different shareholders and companies. The third party may, for example, broker agreements between life insurance companies and shareholders, assist in writing SHOLI policies, monitor the investment of SHOLI assets, and coordinate payments when a SHOLI policy terminates.

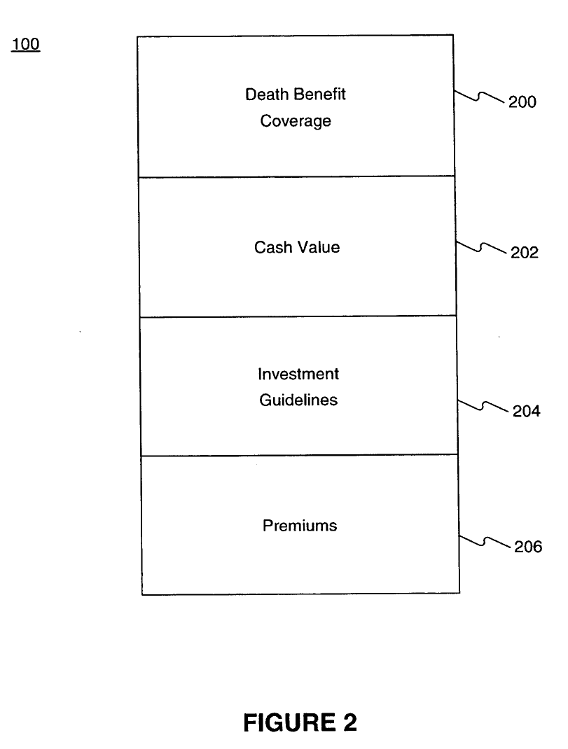

FIG. 2 is a block diagram of SHOLI 100 in greater detail. SHOLI 100 may include death benefit coverage 200, cash value 202, investment guidelines 204, and premiums 206. Death benefits 200 may compensate shareholder 102 for any losses resulting from the death of an employee 106, such as a decline in the company's value, loss of the deceased employee's productivity, costs of benefits due to the employee's survivors, and costs of replacing the employee. Death benefits 200 might also help defray the cost to shareholder 102 of employee benefits offered by company 104, although company employee benefit programs may not be as substantial as those of larger corporations.

Cash value 202 may be based on assets of SHOLI 100 that are invested and managed by institutional money managers pursuant to investment guidelines 204. As such, shareholder 102 may receive associated tax advantages such as tax-free growth of the assets. SHOLI 100 enables shareholder 102 to invest his or her own funds even when company 104 has limited operating capital and could not obtain a traditional COLI policy. Furthermore, SHOLI 100 provides the low costs and favorable terms of an institutional policy that would not normally be available to an individual. Additionally, because a number of employees 106 may be insured, individual underwriting on shareholder 102 may be avoided. If enough employees 106 are insured, SHOLI 100 could further qualify for an experience rated transaction, reducing the cost of insurance each year and lowering the policy's premiums 206 while maintaining a transfer of mortality risk to the insurance company.

SHOLI with Supplemental Death Benefit

Under current law, to purchase a SHOLI product, the shareholder must have an “insurable interest” in the individual lives of the company's insured employees. The amount of insurable interest may depend on many factors, such as an employee's state of residence, the benefits provided to the employee, and the loss the company may incur, directly or indirectly, as a result of the employee's death.

One method consistent with the present investment enhances the amount of insurable interest a shareholder has in the company's employees. For example, to increase the shareholder's insurable interest, the company may offer a large active service death benefit of, for example, $1 million, to its employees. The $1 million would be tax deductible to the company, paid from company treasury, and taxable to the employee's beneficiary. As such, this supplemental death benefit (“SDB”) would be a relatively inexpensive way to increase the shareholder's insurable interest dollar for dollar. The SDB could be provided to employees, for example, in exchange for consent to be insured. Thus, the SDB provides life insurance investment opportunities to a shareholder who could not otherwise receive them either because of state statutes that grant an insurable interest to employers do not include shareholders, or statutes that quantify that insurable interest based on the costs of corporate employee benefit programs.

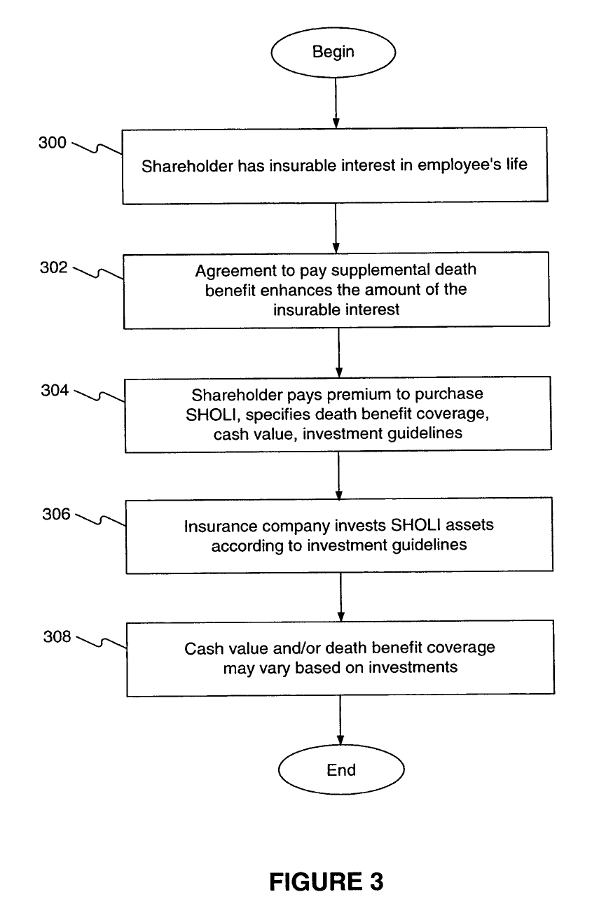

FIG. 3 is a flow chart depicting a process for providing a SHOLI product with a supplemental death benefit. Because shareholder 102 must have an insurable interest in the life of one or more employees 106 to establish a SHOLI policy (step 300), company 104 may agree to pay a SDB to employee 106 to enhance the insurable interest (step 302). Shareholder 102 purchases SHOLI 100 which includes death benefit coverage 200, cash value 202, and investment guidelines 204 and by paying premiums 206 (step 304). According to investment guidelines 204, insurance company 108 may invest the assets of SHOLI 100 (step 306), and cash value 202 and/or death benefit coverage 200 may vary based on the performance of those investments (step 308).

In an embodiment consistent with the present invention, the steps depicted in FIG. 3 may be implemented using a computer system. For example, a third party provider may assist shareholder 102 and company 104 in working with employee 106 and/or insurance company 108. In this embodiment, the third party provider may use computer software and/or hardware, for example, to monitor the investment guidelines, premium payments, and agreement with employee 106. In another embodiment, insurance company 108 or shareholder 102 may use a computer system to administer SHOLI 100.

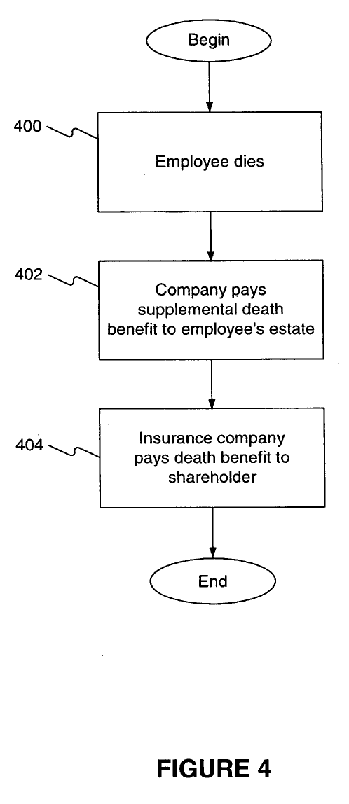

FIG. 4 is a flow chart depicting a process when an insured employee dies under a SHOLI with a SDB. When an employee 106 dies (step 400), company 104 pays the SDB to the employee's estate (step 402). The SDB could be a particularly valuable benefit to employees with families and, as such, could also be an effective employee retention tool. Insurance company 108 then pays death benefit 200 to shareholder 102 (step 404).

In an embodiment consistent with the present invention, the steps depicted in FIG. 4 may be implemented using a computer system. For example, a third party provider may assist shareholder 102 and company 104 in working with the employee's estate and/or the insurance company. In this embodiment, the third party provider may use computer software and/or hardware, for example, to monitor payment of the SDB and/or death benefit 200. In another embodiment, insurance company 108 or shareholder 102 may use a computer system to administer these tasks.

One skilled in the art will recognize that, although FIGS. 1-4 depict and describe one shareholder, SHOLI policy, insurance company, and company, systems and methods consistent with the present invention may include any number of each of these elements. Furthermore, other embodiments will be apparent to those skilled in the art from consideration of the specification and practice of the invention disclosed herein. For example, insurance company 108 and/or shareholder 102 may use a money manager or other party to manage investments according to investment guidelines 204.

SHOLI with Hybrid Fund

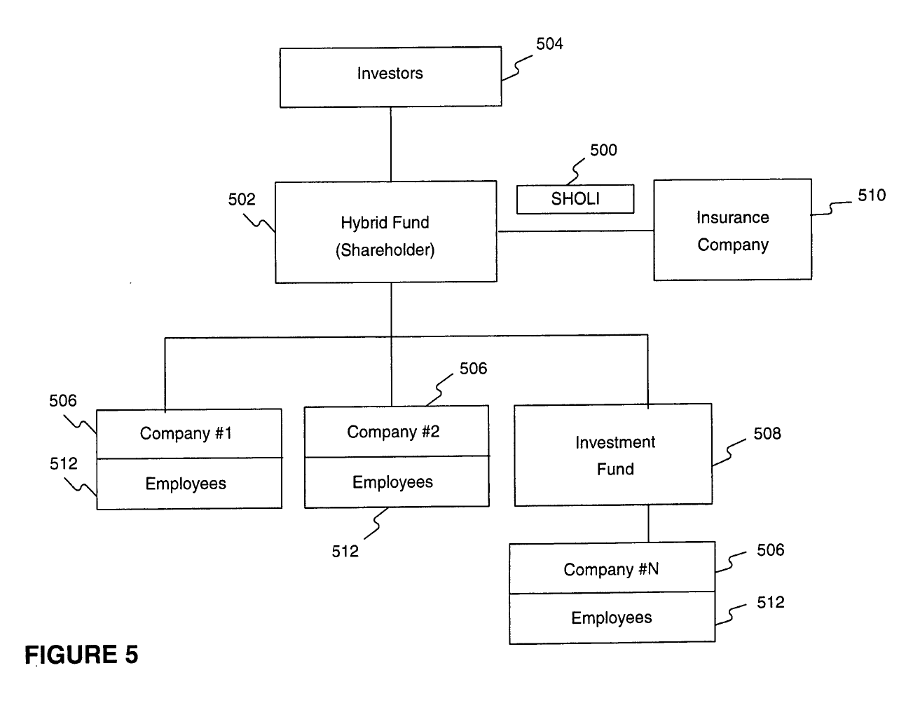

FIG. 5 is a block diagram of a system consistent with the present invention. In this system, a SHOLI product 500 is purchased by a pass-through investment vehicle, referred to herein as a “Hybrid Fund” 502, that serves as the shareholder. Investors 504 may invest in Hybrid Fund 502, which in turn holds an interest in one or more operating companies 506. For example, Hybrid Fund 502 might hold a direct ownership interest in an operating company 506, or it might own an interest in an investment fund 508 that owns interests in one or more operating companies 506. Hybrid Fund 502 may also own an interest in a fund-of-funds that owns interests in a group of investment vehicles and/or owns interests in operating companies 506. Because Hybrid Fund 502 functions as a shareholder, it may purchase SHOLI 500 from insurance company 510 to insure the lives of employees 512.

In an embodiment consistent with the present invention, the process depicted in FIG. 5 may be implemented using a computer system. For example, Hybrid Fund 502 or the third party provider may use computer software and/or hardware, for example, to monitor the investments and interact with investors.

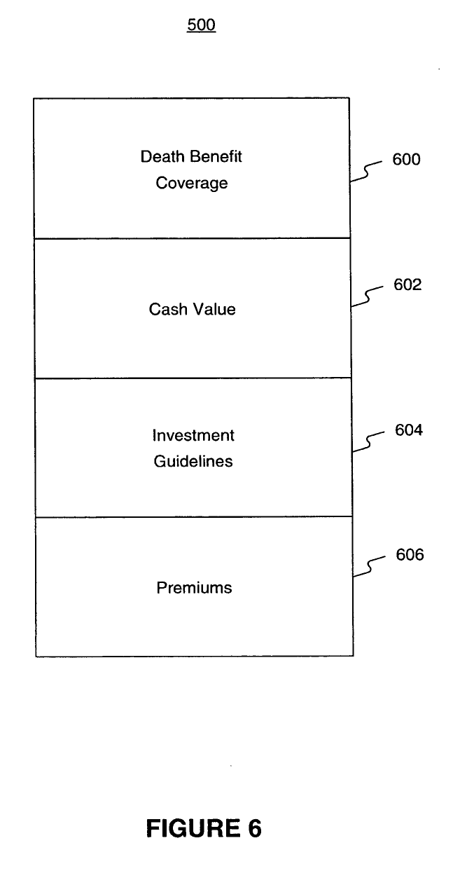

FIG. 6 is a block diagram of SHOLI 500 in greater detail. SHOLI 500 may include death benefit coverage 600, cash value 602, investment guidelines 604, and premiums 606. Death benefits 600 may compensate Hybrid Fund 502 for any losses resulting from the death of an employee 512. Cash value 602 may be based on assets of SHOLI 500 that are invested and managed, for example, by institutional money managers pursuant to investment guidelines 604. As such, Hybrid Fund 502 may receive associated tax advantages such as tax-free growth of the assets. Premiums 606 are paid to insurance company 510 to maintain SHOLI 500.

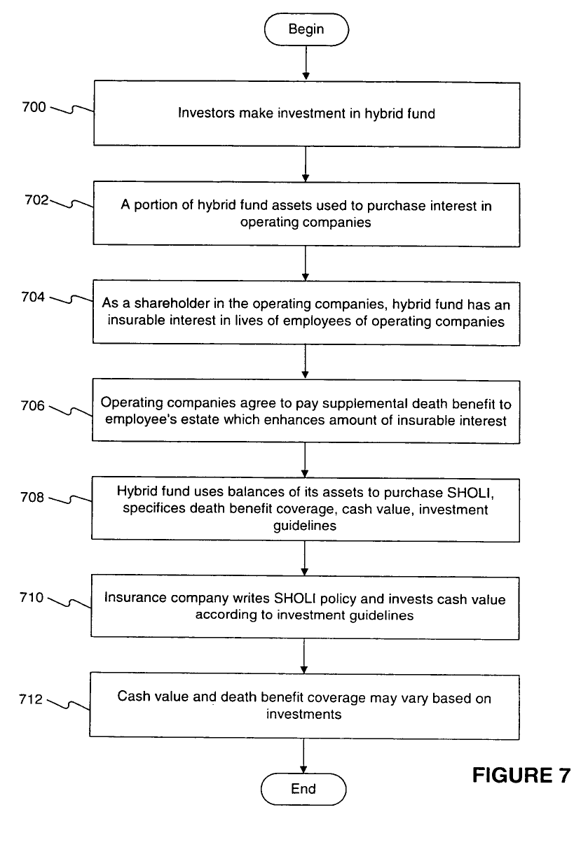

FIG. 7 is a flow chart depicting a process for providing a SHOLI product with a Hybrid Fund consistent with the present invention. Investors 504 make an investment in Hybrid Fund 502 (step 700). Hybrid Fund 502 could then use its funds for different purposes. For example, a portion of the funds could be used to invest in operating companies 506 (step 702). As a shareholder in companies 506, Hybrid Fund 502 has an insurable interest in the lives of employees 512 (step 704). To enhance the amount of that insurable interest, a company 506 may agree to pay a supplemental death benefit (SDB) to an employee 512 (step 706).

As another purpose, Hybrid Fund 502 could use a portion of its funds to make premium payments 606 to purchase insurance covering the life of an employee 512 of operating company 506 (step 708). Pursuant to investment guidelines 604, insurance company 510 invests the SHOLI assets (step 710), and cash value 602 and/or death benefit coverage 600 may vary based on the performance of those investments (step 712).

In an embodiment of the present invention, the steps depicted in FIG. 7 may be performed by a computer system. For example, a software program run by Hybrid Fund 502 or a third party provider may manage SHOLI asset investment, monitor premium payments, and provide investors with reports.

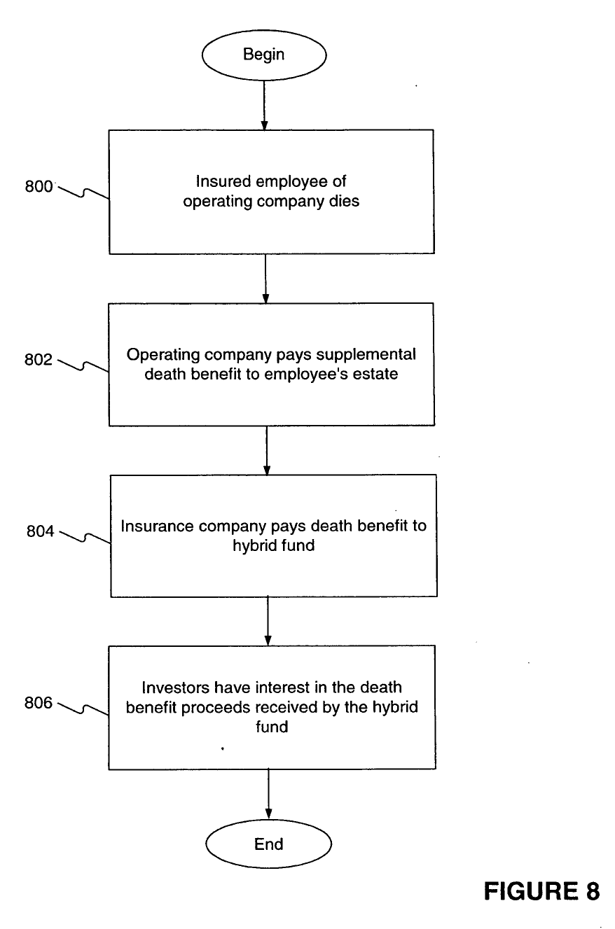

FIG. 8 is a flow chart depicting a process, consistent with the present invention, that would be followed when an insured employee dies under a SHOLI with a Hybrid Fund. When an employee 512 dies (step 800), company 506 pays the supplemental death benefit (SDB) to the employee's estate (step 802). Insurance company 510 then pays death benefit 600 to Hybrid Fund 502 (step 804), and investors 504 have an interest in the death benefit proceeds received by Hybrid Fund 502.

In an embodiment of the present invention, the steps depicted in FIG. 8 may be performed by a computer system. For example, a software program run by Hybrid Fund 502 or a third party provider may manage payment of the SDB and/or death benefits upon the employee's death.

Investors 504 may hedge their investments against the death of one or more employees 512 of operating companies 506 in which they have indirect interests. Investors 504 would also enjoy the benefits of any increased cash value of the insurance policies resulting from the investment of the underlying funds.

When a Hybrid Fund invests in insurance, the tax advantages to the Hybrid Fund investors may be the most significant if the Hybrid Fund opts to hold the most tax-inefficient assets available. Hedge funds are often highly profitable investments; but, they are often high turnover investment vehicles and very tax-innenefficient. Rapid turnover of profitable assets can result in large amounts of taxable income taxed at ordinary rates rather than long-term capital gains rates. Thus, this asset class would reap tax benefits if moved into an insurance product. If a shareholder (including, for example, a Hybrid Fund) decided to sell an entity holding a SHOLI policy, after owning the entity for the required holding period, the shareholder would be entitled to favorable long-term capital gains treatment on the amount by which the sale proceeds exceeded the entity's basis.

One skilled in the art will recognize that, although FIGS. 5-8 depict and describe one investor, Hybrid Fund, SHOLI policy, and insurance company, systems and methods consistent with the present invention may include any number of each of these elements. Similarly, any number of companies and employees may be used. Furthermore, other embodiments will be apparent to those skilled in the art from consideration of the specification and practice of the invention disclosed herein. For example, insurance company 510 may place cash value 602 into a separate account and/or an insurance dedicated fund for investment.

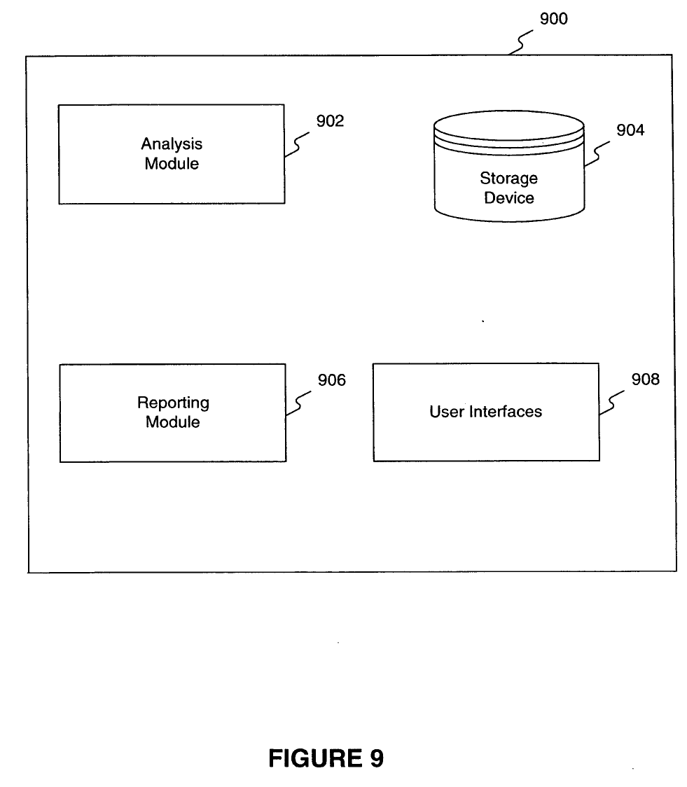

FIG. 9 is a block diagram of a data processing system 900 consistent with the present invention to collect and/or manage data used by investors, shareholders, insurance companies, and/or investment managers to implement a SHOLI product. Data processing system 900 may include an analysis module 902 to track, for example, the performance of a SHOLI product and a storage device 904 to store data relating to a SHOLI product. Data processing system 900 may also include a reporting module 906 to provide reports to, for example, investors, shareholders, insurance companies, and/or investment managers. User interfaces 908 may enable investors, shareholders, insurance companies, and/or investment managers to interact with data processing system 900 to manage SHOLI products consistent with the present invention. The data processing system of FIG. 9 may be used to implement any and all of the systems and methods described in FIGS. 1-8.

Those skilled in the art will readily know of other systems and methods consistent with the invention by considering the specification or by practicing the invention. The specification should be considered exemplary, with a true scope and spirit of the invention being indicated by the following claims.

What is claimed is:

1. An automated method for providing a shareholder-owned life insurance product, comprising:
providing a death benefit from a company to an employee of the company;
insuring the life of the employee for the benefit of a shareholder of the company; and
investing assets related to the insurance for the benefit of the shareholder using a data processor.

2. The method of claim 1, wherein insuring the life of the employee for the benefit of the shareholder includes insuring the life of the employee for the benefit of a hybrid fund with an investor, wherein the hybrid fund purchases an interest in the company.

3. A method for providing a shareholder-owned life insurance product, comprising:
insuring the life of an employee of a company for the benefit of a shareholder of the company; and
investing assets related to the insurance for the benefit of the shareholder using a data processor.

4. The method of claim 3, wherein the shareholder is a hybrid fund.

5. The method of claim 4, wherein investing includes managing the assets of a shareholder-owned life insurance product by at least one of a third party provider and software program run by the hybrid fund.

6. The method of claim 4, wherein the hybrid fund holds an interest in the company through at least one intermediary investment account.

7. The method of claim 5, wherein the at least one intermediary investment account is an investment fund.

8. The method of claim 3, further comprising:
providing a supplemental death benefit from the company to the employee of the company.

9. A computer-readable medium containing instructions for controlling a data processing system to perform a method for providing a shareholder-owned life insurance product, said method comprising the steps of:
insuring the life of an employee of a company for the benefit of a shareholder of the company; and
investing assets related to the insurance for the benefit of the shareholder using a data processor.

10. A method of providing a shareholder-owned life insurance product, comprising:
providing supplemental death benefits to an employee of a company, wherein the supplemental death benefits are paid from company assets; and
insuring the employee for the benefit of a shareholder of the company using a data processor.

11. A computer-readable medium containing instructions for controlling a data processing system to perform a method for providing a shareholder-owned life insurance product, said method comprising the steps of:
providing supplemental death benefits to an employee of a company;
insuring the employee for the benefit of a shareholder of the company using a data processor.

12. A shareholder-owned life insurance product, comprising:
a life insurance policy owned by a shareholder of a company, wherein the policy insures the life of an employee of the company.

13. The shareholder-owned life insurance product of claim 12, wherein an insurance company provides the policy to the shareholder.

14. The shareholder-owned life insurance product of claim 13, where further comprising a cash value to the shareholder.

15. The shareholder-owned life insurance product of claim 14, wherein the cash value is invested by the insurance company according to investment guidelines.

16. The shareholder-owned life insurance product of claim 12, further comprising premiums payable by the shareholder.

17. The shareholder-owned life insurance product of claim 12, wherein the life insurance policy compensate the shareholder for a loss to the company resulting from the death of an employee and the cost of employee benefits offered by the company.

18. The shareholder-owned life insurance product of claim 12, wherein the cash value is based on assets invested and managed by an institutional money manager pursuant to the investment guidelines.

19. A data processing system, comprising:
an analysis module for tracking performance of a shareholder-owned life insurance product;
a storage device for storing data relating to the shareholder-owned life insurance product; and
a reporting module for providing reports on the shareholder-owned life insurance product

20. The data processing system of claim 19, further comprising a user interface.
